(19) United States
(12) Patent Application Publication
(10) Pub. No.: US 2026/0252089 A1
(43) Pub. Date: Aug. 27, 2026

(54) CONTROL SYSTEM, CONTROL DEVICE, CONTROL METHOD, AND PROGRAM

(71) Applicants: NEC Corporation, Tokyo (JP); NEC Communication Systems, Ltd., Tokyo (JP)

(72) Inventors: Taichi KUMAGAI, Tokyo (JP); Jingxiang CHEN, Tokyo (JP)

(73) Assignees: NEC Corporation, Tokyo (JP); NEC Communication Systems, Ltd., Tokyo (JP)

(21) Appl. No.: 19/161,822

(22) PCT Filed: Feb. 20, 2024
(86) PCT No.: PCT/JP2024/005997

§ 371 Date: Sep. 3, 2025

(30) Foreign Application Priority Data
Mar. 15, 2023 (JP) 2023-040571

(51) Int. Cl. G05D 1/249; G06T 7/73; G06V 20/58

(52) U.S. Cl. CPC G05D 1/249; G06T 7/73; G06V 20/58; G06T 2207/30252

(57) ABSTRACT

The objective of the present invention is to provide a control system which enables a conveying vehicle to convey an object to be conveyed, even if a camera is installed out of position. A control system according to the present disclosure comprises: a change unit which, in accordance with the inclination of an imaging device that has captured a first video, changes position information relating to a plurality of feature points indicating an object to be conveyed that appears in the first video; a selecting unit that uses the changed feature point position information to select a method for identifying the disposition of a surface of the object to be conveyed; and a control unit that controls a moving body for conveying the object to be conveyed, in accordance with the disposition of the surface of the object to be conveyed identified in accordance with the selected identification method.

### TECHNICAL FIELD

The present disclosure relates to a control system, a control device, and a control method.

### BACKGROUND ART

A conveyance system that conveys an object to be conveyed, using a robot has been studied. PTL 1 discloses identifying a contact position on an object to be conveyed with which a conveying vehicle comes into contact during conveyance of the object to be conveyed, using a captured image captured by a camera installed on a ceiling. Specifically, PTL 1 discloses identifying a contact position, based on positions of an upper surface and a side surface of the object to be conveyed deduced in accordance with the position of the object to be conveyed appearing in the captured image.

### CITATION LIST

### Patent Literature

PTL 1: WO 2021/171618 A1

### SUMMARY OF INVENTION

### Technical Problem

In PTL 1, the captured image captured by the camera appropriately installed at a predetermined position on the ceiling is premised to be used. However, in practice, the work of installing the camera on the ceiling is often performed by a person, and the camera may sometimes be installed out of position at the predetermined position. Therefore, there is a disadvantage that the position of the object to be conveyed appearing in the captured image that has been thus captured is out of the position of the object to be conveyed appearing in the captured image captured if the camera is installed without being out of position at the predetermined position. It is desired to cope with even a case where the camera is installed out of position at the predetermined position in such a way that the conveying vehicle is allowed to convey the object to be conveyed.

In view of the above-described problems, an objective of the present disclosure is to provide a control system, a control device, and a control method that enable a conveying vehicle to convey an object to be conveyed even in a case where a camera is installed out of position.

### Solution to Problem

A control system according to a first aspect of the present disclosure includes a change unit for, in accordance with an inclination of an image capturing device that has captured a first video, changing position information relating to a plurality of feature points indicating an object to be conveyed that appears in the first video, a selecting unit for selecting a method for identifying disposition of a surface of the object to be conveyed, using the changed position information relating to the feature points, and a control unit for controlling a moving body for conveying the object to be conveyed, in accordance with the disposition of the surface of the object to be conveyed identified in accordance with the selected method for the identifying.

A control device according to a second aspect of the present disclosure includes a change unit for, in accordance with an inclination of an image capturing device that has captured a first video, changing position information relating to a plurality of feature points indicating an object to be conveyed that appears in the first video, a selecting unit for selecting a method for identifying disposition of a surface of the object to be conveyed, using the changed position information relating to the feature points, and a control unit for controlling a moving body for conveying the object to be conveyed, in accordance with the disposition of the surface of the object to be conveyed identified in accordance with the selected method for the identifying.

A control method according to a third aspect of the present disclosure includes, in accordance with an inclination of an image capturing device that has captured a first video, changing position information relating to a plurality of feature points indicating an object to be conveyed that appears in the first video, selecting a method for identifying disposition of a surface of the object to be conveyed, using the changed position information relating to the feature points, and controlling a moving body for conveying the object to be conveyed, in accordance with the disposition of the surface of the object to be conveyed identified in accordance with the selected method for the identifying.

### Advantageous Effects of Invention

According to the present disclosure, a control system, a control device, and a control method that enable a conveying vehicle to convey an object to be conveyed even in a case where a camera is installed out of position can be provided.

### BRIEF DESCRIPTION OF DRAWINGS

FIG. 1 is a configuration diagram of a control system according to the present disclosure.

FIG. 2 is a diagram illustrating a flow of a control process according to the present disclosure.

FIG. 3 is a configuration diagram of a conveyance system according to the present disclosure.

FIG. 4 is a configuration diagram of a control device according to the present disclosure.

FIG. 5 is a diagram illustrating a flow of a control process according to the present disclosure.

FIG. 6 is a diagram explaining correction using an inclination angle according to the present disclosure.

FIG. 7 is a diagram explaining patterns of a position of a circumscribed frame R according to the present disclosure.

FIG. 8 is a diagram illustrating an imaged state of an object to be conveyed, in a case where the position of the circumscribed frame R is in a first pattern according to the present disclosure.

FIG. 9 is a diagram illustrating an imaged state of an object to be conveyed, in a case where the position of the circumscribed frame R is in a second or third pattern according to the present disclosure.

FIG. 10 is a diagram illustrating an outline of a contact position identifying process according to the present disclosure.

FIG. 11 is a diagram illustrating an example of display information according to the present disclosure.

FIG. 12 is a diagram explaining a method for calculating a second particular region R2 of the object to be conveyed according to the present disclosure.

FIG. 13 is a diagram illustrating a relationship between the circumscribed frame R and particular regions in the first pattern according to the present disclosure.

FIG. 14 is a first diagram illustrating a relationship between the circumscribed frame R and a particular region in the second pattern according to the present disclosure.

FIG. 15 is a second diagram illustrating a relationship between the circumscribed frame R and a particular region in the second pattern according to the present disclosure.

FIG. 16 is a diagram illustrating a relationship between the circumscribed frame R and a particular region in the third pattern according to the present disclosure.

FIG. 17 is a diagram explaining a method for calculating a first particular region R1 of the object to be conveyed according to the present disclosure.

FIG. 18 is a configuration diagram of a control device according to the present disclosure.

### EXAMPLE EMBODIMENT

### First Example Embodiment

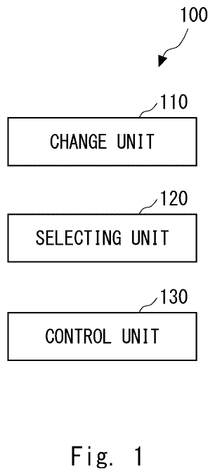

A control system 100 in FIG. 1 includes a change unit 110, a selecting unit 120, and a control unit 130. The change unit 110, the selecting unit 120, and the control unit 130 may be referred to as a change means, a selecting means, and a control means, respectively. The change unit 110, the selecting unit 120, and the control unit 130 may be software or modules in which processing is executed by a processor executing a program stored in a memory. Alternatively, the change unit 110, the selecting unit 120, and the control unit 130 may be hardware such as circuits or chips.

The change unit 110, the selecting unit 120, and the control unit 130 may be provided in different computer devices from each other, or may be provided in one computer device. Alternatively, two of the change unit 110, the selecting unit 120, and the control unit 130 may be provided in one computer device.

The computer device may be a device operated by a processor executing a program stored in a memory. In a case where the change unit 110, the selecting unit 120, and the control unit 130 are disposed in a distributed manner in different computer devices, the computer devices may communicate with each other via a network. The network may be a wireless network or a fixed communication network.

The change unit 110 changes position information on a plurality of feature points indicating an object to be conveyed appearing in a first video, in accordance with the inclination of an image capturing device that has captured the first video. The first video may be, for example, an image captured by the image capturing device such as a camera or a sensor. For example, the image may be a still image captured by the image capturing device, or may be a frame image constituting moving image data captured by the image capturing device.

Whether the plurality of feature points indicates an object to be conveyed may be determined using, for example, a learning model in which the shape and the like of an object to be conveyed have been learned in advance using artificial intelligence (AI), machine learning, or the like. Alternatively, in a case where a background image in which no object to be conveyed appears is generated in advance, the change unit 110 may identify a region in which a change has occurred between the first video and the background image, as a region in which the object to be conveyed exists, and may identify a feature point in the identified region, as the object to be conveyed. The feature point may be extracted using the gradient of luminance or the like in each pixel constituting the video, for example. As an algorithm for extracting feature points, for example, Scale Invariant Feature Transformation (SIFT) or the like may be used.

The image capturing device is installed at a predetermined position and images a particular region. Here, the image capturing device may sometimes be installed in an inclined manner at the predetermined position. The installation in an inclined manner may mean, for example, installation at a position having, as an image capturing direction, a direction different from the image capturing direction in a case where the image capturing device is normally installed. The inclination may also be indicated using an angle. For example, the inclination may be an angle formed by an imaging direction axis of an imaging direction of the image capturing device in a case where the image capturing device is installed facing a predefined direction at the predetermined position and an imaging direction axis of the image capturing device installed facing a direction inclined from the predefined direction at the predetermined position. The imaging direction axis of the imaging direction may be, for example, a straight line passing through the center of the angle of view of the image capturing device.

Changing the position of the feature point using the inclination of the image capturing device may be rephrased as correcting the position of the feature point using the inclination of the image capturing device. That is, the change unit 110 may correct the position of the feature point to a position that appears in an image captured if the imaging device is not inclined.

The selecting unit 120 selects a method for identifying the disposition of a surface of the object to be conveyed, using the changed position information on the feature points. Here, a method for identifying the disposition of a surface of the object to be conveyed will be described. For example, in a case where the image capturing device images an object to be conveyed arranged below from above, a location of the object to be conveyed included in the image varies depending on a positional relationship between the image capturing device and the object to be conveyed. Specifically, depending on the positional relationship between the image capturing device and the object to be conveyed, a side surface of the object to be conveyed may be included in the image in some cases but may not be included in other cases. For example, in a case where the object to be conveyed is arranged in the vicinity of the center of an imaging region of the image capturing device, an upper surface of the object to be conveyed appears in the image, but a side surface of the object to be conveyed does not appear in the image. On the other hand, in a case where the object to be conveyed is arranged at a position away from the vicinity of the center of the imaging region of the image capturing device, the object to be conveyed is imaged obliquely from above, and thus, an upper surface and a side surface of the object to be conveyed appear in the image. That is, in identifying the disposition of a surface of the object to be conveyed as it appears in the image, a case where a side surface of the object to be conveyed is included in the region where the object to be conveyed appears and a case where a side surface of the object to be conveyed is not included in the region arise according to the position of the object to be conveyed. According to the above, the selecting unit 120 selects the method for identifying the disposition of a surface of the object to be conveyed in accordance with which position or which region of the image the changed feature point exists.

The control unit 130 controls a moving body for conveying the object to be conveyed, in accordance with the disposition of a surface of the object to be conveyed identified in accordance with the selected identification method. The control may mean adjusting the position and speed of the moving body, the height and position of a contact portion at which the moving body comes into contact with the object to be conveyed, and the like. The control unit 130 may deduce a position where the moving body fixes the object to be conveyed in order to convey the object to be conveyed, in accordance with the identified shape of the object to be conveyed. In this case, the control unit 130 controls the moving body in accordance with a location where the object to be conveyed is supported and the disposition of a surface of the object to be conveyed. Specifically, the control unit 130 moves the moving body to the deduced position of the object to be conveyed and further moves the moving body to which the object to be conveyed is fixed to a target position. The moving body may be a vehicle that can be manipulated remotely and may be, for example, an automatic guided vehicle (AGV) or a drone. Alternatively, the moving body may be a robot that moves autonomously.

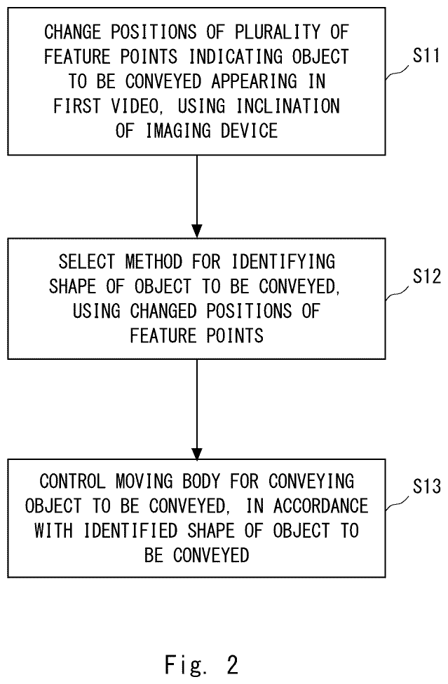

Subsequently, a flow of a control process in the control system 100 will be described with reference to FIG. 2. The control process in the control system 100 may be executed by, for example, a control device including the change unit 110, the selecting unit 120, and the control unit 130.

First, the change unit 110 changes the position information on a plurality of feature points indicating the object to be conveyed appearing in the first video, in accordance with the inclination of the image capturing device that has captured the first video (S11). Next, the selecting unit 120 selects a method for identifying the disposition of a surface of the object to be conveyed, using the changed position information on the feature points (S12). Next, the control unit 130 controls the moving body for conveying the object to be conveyed, in accordance with the disposition of a surface of the object to be conveyed identified in accordance with the selected identification method (S13).

As described above, even in a case where the image capturing device that images the object to be conveyed is installed in an inclined manner, the control system 100 changes the position information on a plurality of feature points indicating the object to be conveyed appearing in a video, using the inclination of the image capturing device. Furthermore, the control system 100 identifies the disposition of a surface of the object to be conveyed, in accordance with the changed position information on the feature points. As a result, the control system 100 can appropriately identify the position of the object to be conveyed appearing in the captured image even in a case where the image capturing device is installed out of position. Moreover, the control system 100 can cause the moving body to reliably convey the object to be conveyed by appropriately identifying the position of the object to be conveyed.

### Second Example Embodiment

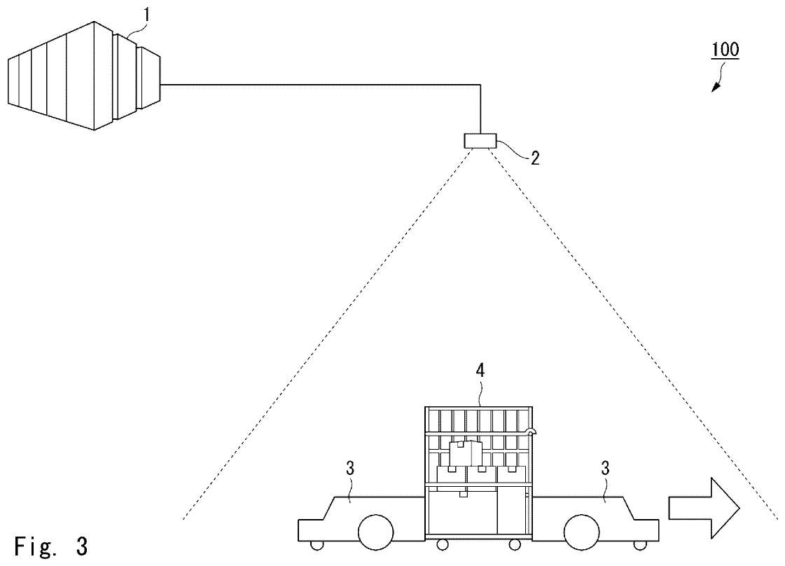

A configuration example of a conveyance system will be described with reference to FIG. 3. A conveyance system 101 illustrated in FIG. 3 includes a control device 1, a sensor 2, and a conveying vehicle 3.

The sensor 2 measures information regarding an object to be conveyed 4. The sensor 2 transmits the measured information regarding the object to be conveyed 4 to the control device 1. In more detail, the sensor 2 may be an image capturing device that images the inside of a field where the conveying vehicle 3 can move. The sensor 2 may be, for example, a depth camera or a stereo camera. The sensor 2 may also be a gyro sensor. The sensor 2 may be made up of several sensors including an image capturing device such as a depth camera or a stereo camera and a gyro sensor, or may be one sensor having the function of the image capturing device and the function of the gyro sensor. The sensor 2 images a surface on which the conveying vehicle 3 travels, such as a floor surface. The sensor 2 generates or measures image information and distance information in a range centered on a downward axis from the vicinity of the ceiling on which the sensor 2 is installed toward the floor surface. The sensor 2 generates the image information obtained by imaging a measurement range of the sensor 2 and the distance information indicating a distance to each position in the measurement range of the sensor 2. The measurement range represents, for example, a range that can be measured by the sensor 2. For example, in the case of a camera, the measurement range refers to a range appearing in the camera. The measurement range may be identified using an angle of view or the like of the camera, for example. The distance information indicates, for example, a distance from the sensor 2 to a position relevant to each pixel of the image information included in the measurement range. The sensor 2 as a gyro sensor measures an inclination angle of the image capturing device. The inclination angle may be an angle formed by an imaging direction axis in a case where the image capturing device is installed facing a particular direction and an imaging direction axis in a direction in which the image capturing device performs imaging. For example, the inclination angle may be an angle formed by an axis in a direction substantially perpendicular to the floor surface and the imaging direction axis of the image capturing device. The imaging direction axis of the image capturing device may be, for example, a straight line passing through the center of the angle of view of the image capturing device.

The control device 1 corresponds to the control system 100 in FIG. 1. The control device 1 controls the conveying vehicle 3. The control device 1 controls the conveying vehicle 3, based on acquired information. Controlling the conveying vehicle 3 may mean controlling the operation of the conveying vehicle 3. The control device 1 communicates with the sensor 2 that measures the object to be conveyed 4, and the conveying vehicle 3. The control device 1 acquires information regarding the inclination angle, the image information, and the distance information from the sensor 2. The control device 1 identifies a position at which the conveying vehicle 3 comes into contact with the object to be conveyed 4, during the conveying vehicle 3 conveys the object to be conveyed 4, based on the information regarding the inclination angle and the information regarding the object to be conveyed 4 (the image information and the distance information), and controls the conveying vehicle 3, based on the identified position at which the conveying vehicle 3 comes into contact the object to be conveyed 4. The control device 1 may control one conveying vehicle 3 or may control a plurality of conveying vehicles 3. The conveying vehicle 3 may be an aspect of a robot.

The object to be conveyed 4 is an object intended to be conveyed, which is, in one example, a cart, a carriage, or the like on which a cargo is placed, and is only required to be a movable object. The conveying vehicle 3 conveys the object to be conveyed 4 under the control of the control device 1 or based on an instruction from the control device 1. The conveying vehicle 3 receives, from the control device 1, information on a contact position indicating a position at which the conveying vehicle 3 comes into contact with the object to be conveyed 4 and conveys the object to be conveyed 4 by, for example, pushing or pulling the contact position. The contact position is a part of the object to be conveyed at which the conveying vehicle 3 supports the object to be conveyed 4.

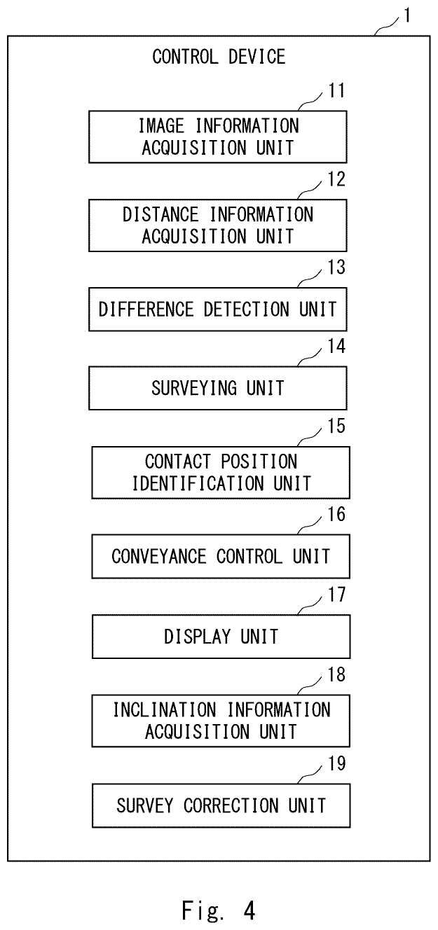

Subsequently, a configuration example of the control device 1 will be described with reference to FIG. 4. The control device 1 may be a computer device. The control device 1 includes an image information acquisition unit 11, a distance information acquisition unit 12, a difference detection unit 13, a surveying unit 14, a contact position identification unit 15, a conveyance control unit 16, a display unit 17, an inclination information acquisition unit 18, and a survey correction unit 19. Each component constituting the control device 1 may be software or a module in which processing is executed by a processor executing a program stored in a memory. Alternatively, each component constituting the control device 1 may be hardware such as a circuit or a chip.

The change unit 110 in FIG. 1 corresponds to the survey correction unit 19. The selecting unit 120 in FIG. 1 corresponds to the surveying unit 14. The control unit 130 in FIG. 1 corresponds to the contact position identification unit 15 and the conveyance control unit 16. The contact position identification unit may be referred to as an identification unit.

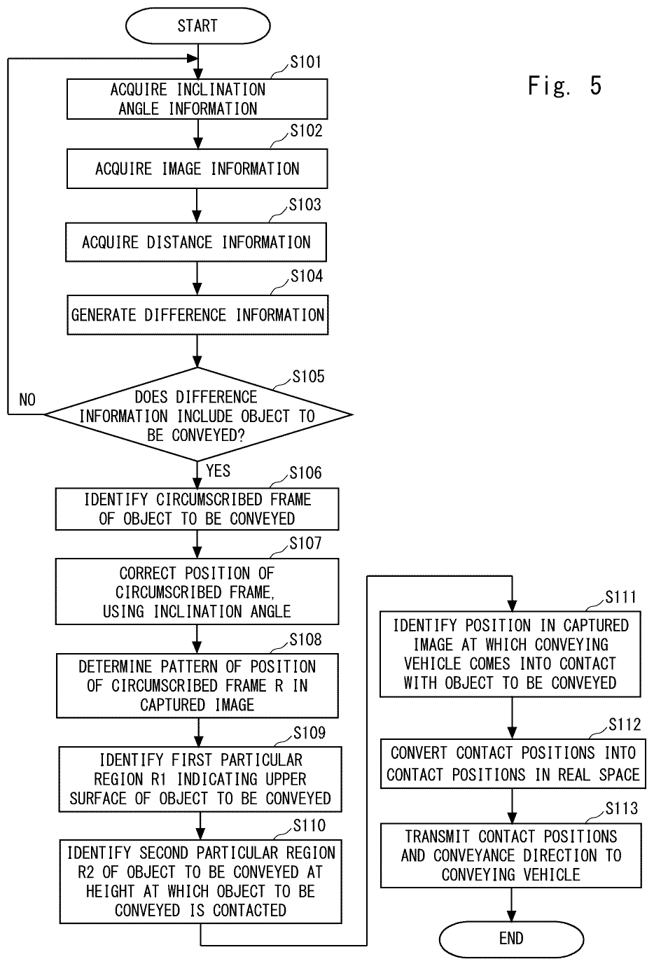

Here, the function or operation of each component of the control device 1 will be described using the processing flow illustrated in FIG. 5. First, the inclination information acquisition unit 18 acquires inclination information (step S101). Specifically, the inclination information acquisition unit 18 acquires an inclination angle of the sensor 2 as an image capturing device from the sensor 2 as a gyro sensor. For example, in a case where the acquired inclination information is larger than a predefined angle, the inclination information acquisition unit 18 may output an alarm indicating that an anomaly has arisen. The inclination information acquisition unit 18 may acquire inclination angles of a plurality of image capturing devices, using a plurality of gyro sensors. In this case, if the inclination angles of a predefined number or more of image capturing devices are larger than the predefined angle, the inclination information acquisition unit 18 may output an alarm indicating that an anomaly has arisen.

Next, the image information acquisition unit 11 acquires the image information (step S102). Specifically, the image information acquisition unit 11 receives the image information containing several frames per second, such as 30 frames per second, for example, from the sensor 2. The image information acquisition unit 11 may generate a background image, based on the image information, and record the image information and information regarding the background image in a storage unit such as a memory included in the control device 1 or a memory attached to the control device 1. The background image may be generated and recorded before the object to be conveyed 4 is detected. For example, the background image may be generated at a time at which the control device 1 starts the operation, may be generated at a timing at which an administrator of the control device 1 instructs recording, or may be generated at any timing. The background image may be image information in a case where the conveying vehicle 3, the object to be conveyed 4, an obstacle, or other foreign matter is not included in the measurement range.

Next, the distance information acquisition unit 12 acquires the distance information (step S103). Specifically, the distance information acquisition unit 12 may receive the distance information containing 30 frames or the like per second, for example, from the sensor 2. It is supposed that the image information received by the image information acquisition unit 11 and the distance information received by the distance information acquisition unit 12 have equal reception timings. The image information and the distance information indicate information regarding the same region. That is, the distance information is information indicating a distance to each pixel included in the image information received at the same timing. The distance information acquisition unit 12 may record the distance information received from the sensor 2 in a storage unit such as a memory included in the control device 1 or a memory attached to the control device 1. The image information acquisition unit 11 and the distance information acquisition unit 12 may give same identification information, related pieces of identification information, or the like to the image information and the distance information in such a way that the relationship between the image information and the distance information received at substantially the same timing from the sensor 2 is established.

Next, the difference detection unit 13 generates or creates difference information indicating a difference between the image information accepted from the image information acquisition unit 11 and the background image (step S104). The generation and creation will be explained as the same meaning in the following description. Specifically, after acquiring the image information, the difference detection unit 13 compares the acquired image information with the background image. The difference detection unit 13 generates the difference information indicating or identifying a region in which a change has occurred between the image information and the background image. For example, the difference detection unit 13 binarizes the image information and the background image individually into pixels using “0” and “1”, in accordance with the luminance of each pixel, and generates the difference information indicating a difference in each pixel between these binarized image information and binarized background image. A pixel whose difference indicates “1” in the difference information indicates that some object such as an obstacle or a person, for example, is located in the measurement range. The difference detection unit 13 outputs the difference information to the surveying unit 14.

Next, the surveying unit 14 determines whether the acquired difference information includes the object to be conveyed 4 (step 105). For example, the surveying unit 14 may determine whether the conveying vehicle 3 is located in the measurement range and may determine that the object to be conveyed 4 is included in the difference information in a case where information other than the conveying vehicle 3 is included in the difference information. The conveying vehicle 3 may detect the position of the conveying vehicle 3 and transmit the detected position to the control device 1, or the sensor 2 may detect the position of the conveying vehicle 3 and transmit the detected position to the control device 1. The surveying unit 14 may determine whether the conveying vehicle 3 is located in the measurement range by comparing the position information on the conveying vehicle 3 with the position information on the measurement range measured by the sensor 2 and stored in advance.

The surveying unit 14 may also detect the position of the conveying vehicle 3 from the image information, using features of the conveying vehicle 3 stored in advance, and may identify whether the conveying vehicle 3 is located within the measurement range. Here, the features of the conveying vehicle 3 stored in advance are luminance, size, and the like of the conveying vehicle 3, for example. The method for the surveying unit 14 to detect the position of the conveying vehicle 3 is not limited to the above. In a case where the conveying vehicle 3 exists in the measurement range, the surveying unit 14 may mask a region of the conveying vehicle 3 in the measurement range indicated by the difference information and generate the difference information.

In the above, the surveying unit 14 determines whether the conveying vehicle 3 exists in the measurement range and determines whether the object to be conveyed 4 is included in the difference information acquired from the difference detection unit 13 in a case where the difference information includes information other than the conveying vehicle 3. However, the identification as to whether the object to be conveyed 4 is included is not limited to the above.

For example, in a case where the object to be conveyed 4 or the conveying vehicle 3 is included in the measurement range, the surveying unit 14 may determine whether the object to be conveyed 4 is included in the difference information, based on information on a predefined size of the object to be conveyed 4. The surveying unit 14 identifies an inclusion region including the object to be conveyed 4. For example, the surveying unit 14 determines the size or the area of a region of a collection of pixels indicating that there is a difference in the difference information.

The surveying unit 14 may also determine whether the object to be conveyed 4 is included in the image information, using a learning model in which the object to be conveyed 4 has been learned in advance by AI or machine learning.

In a case where the surveying unit 14 determines that the object to be conveyed 4 is not included in the difference information, the surveying unit 14 repeats the process in step S101. Alternatively, considering that the inclination is less likely to change in a short time, the surveying unit 14 may repeat the process in step S102.

In a case where the region of the collection of pixels whose differences indicate 1 in the difference information has a certain size or more, the surveying unit 14 identifies an outer frame of the region having the certain size or more, as a circumscribed frame R of the object to be conveyed 4 (step S106). The circumscribed frame R may indicate a frame of the inclusion region including an upper surface or a side surface of the object to be conveyed 4 as an object intended to be measured. The method for identifying the circumscribed frame R is not limited to the above method, and the surveying unit 14 may determine the circumscribed frame R of the region of the object to be conveyed 4 included in the difference information by another approach. For example, the surveying unit 14 may generate the circumscribed frame R in such a way as to surround the identified object to be conveyed 4. The circumscribed frame R may have a rectangular shape, a shape having a curved line, or any other shape.

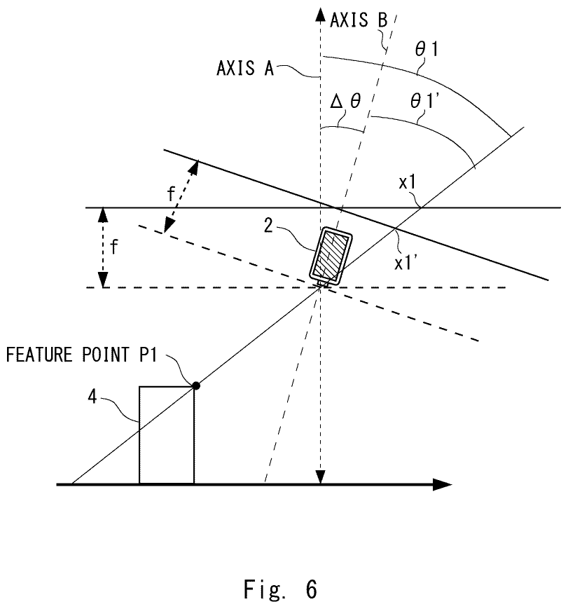

Subsequently, the survey correction unit 19 corrects the position of the identified circumscribed frame R, using the inclination angle (step S107). Here, correction using the inclination angle will be described with reference to FIG. 6.

FIG. 6 illustrates how the sensor 2 as an image capturing device is installed on a ceiling in an inclined manner. FIG. 6 illustrates that the sensor 2 installed in an inclined manner images the object to be conveyed 4. A focal length used by the sensor 2 for capturing the image information is denoted by f. A feature point P1 indicates any feature point on the upper surface of the object to be conveyed 4 in the real space. An axis A indicates an imaging direction axis of the sensor 2 in a case where the sensor 2 is installed without inclination. An axis B indicates an imaging direction axis of the sensor 2 installed in an inclined manner. The inclination angle is denoted by Δθ, which is an angle formed by the axes A and B. An angle formed by a straight line connecting the feature point P1 and the sensor 2 and the axis B is denoted by θ1′. An angle formed by a straight line connecting the feature point P1 and the sensor 2 and the axis A is denoted by θ1. A point x1′ denotes a position of the feature point P1 included in the captured image captured by the sensor 2 installed in an inclined manner and indicates a distance from the axis B. A point x1 denotes a position of the feature point P1 included in the captured image captured by the sensor 2 installed without inclination and indicates a distance from the axis A.

Here, changing the position information on the feature point to position information at which the feature point will be located in a case where the sensor 2 corresponding to the image capturing device is installed facing a particular direction will be described. Specifically, a correction process for x1′ included in the captured image captured by the sensor 2 installed in an inclined manner to x1 included in a captured image that will be captured by the sensor 2 in a case where the sensor 2 is installed without inclination will be described with reference to FIG. 6. The captured image that will be captured by the sensor 2 is a captured image presumed to be generated in the event that supposed to be captured by the sensor 2 installed without inclination and is not an image actually captured.

In FIGS. 6, x1 and x1′ are expressed using following Formulas (1) and (2). In the formulas below, “/” represents division, and “·” represents multiplication.

$$x 1 = f \cdot tan ( θ 1 ) \qquad ( 1 )$$

$$x 1 = f \cdot tan ( θ {1}^{′} ) \qquad ( 2 )$$

Here, since θ1=θ1′+Δθ is true, Formula (1) is transformed into following Formula (3).

$$x 1 = f \cdot \frac{tan ( θ 1 ′ ) + tan ( Δθ )}{1 - tan ( θ 1 ′ ) \cdot tan ( Δθ )} \qquad ( 3 )$$

Furthermore, by applying Formula (2) to Formula (3), following Formula (4) is derived.

$$x 1 = \frac{x 1 ′ + f \cdot tan ( Δθ )}{1 - \frac{x 1 ′}{f} tan ( Δθ )} \qquad ( 4 )$$

In this manner, x1 included in a captured image that will be captured by the sensor 2 in a case where the sensor 2 is installed without inclination is represented using the focal length f, the inclination angle Δθ, and x1′ included in the captured image captured by the sensor 2 installed in an inclined manner.

The correction process is similarly performed also for each feature point on the circumscribed frame R. For example, in a case where the circumscribed frame R has a rectangular shape, the feature points to be subjected to the correction process include feature points indicating vertexes of the rectangular shape and may further include any feature point on the circumscribed frame R. That is, the position information on the feature points on the rectangular shape may be changed using the inclination.

Returning to FIG. 5, the surveying unit 14 determines a pattern of the position of the circumscribed frame R after the correction process has been performed (step S108). The circumscribed frame R after the correction process has been performed is a circumscribed frame included in the captured image captured by the sensor 2 installed without inclination.

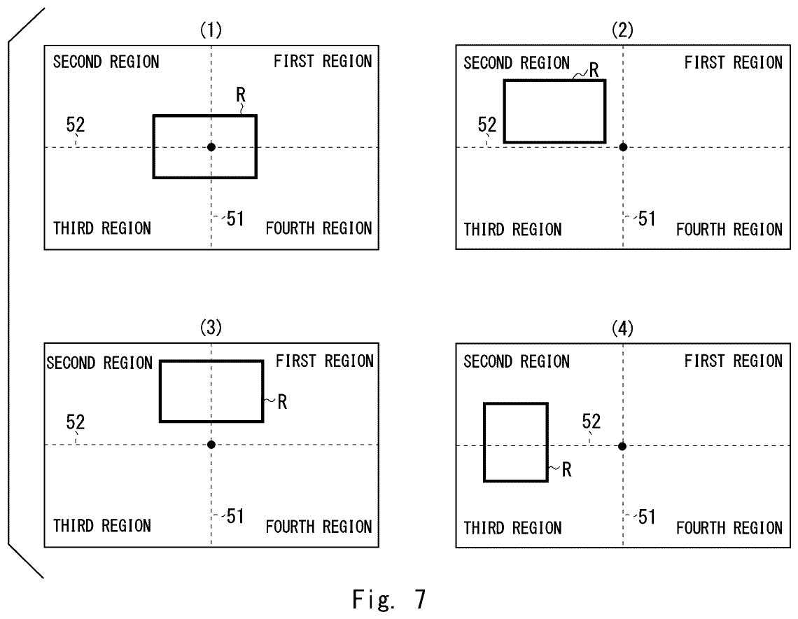

Here, a process executed by the surveying unit 14 to select a method for identifying the disposition of a surface in accordance with the region including the changed position information on the feature points, among regions obtained by dividing the measurement range of the image capturing device installed facing the particular direction into a plurality of regions, will be described. Specifically, patterns of the position of the circumscribed frame R will be described with reference to FIG. 7. The surveying unit 14 determines which of first to third patterns is related to the pattern of the position of the circumscribed frame R in the captured image (step S108). Hereinafter, the measurement range of the sensor 2 is divided using a vertical line 51 and a horizontal line 52 passing through the center of the measurement range, and the upper right is described as a first region, the upper left is described as a second region, the lower left is described as a third region, and the lower right is described as a fourth region.

FIG. 7(1) illustrates the first pattern of the position of the circumscribed frame R. The first pattern is a pattern in which four vertexes of the circumscribed frame R are included in each of the first to fourth regions. The first pattern is a pattern that appears in a case where the circumscribed frame R including the object to be conveyed 4 is located in the vicinity of the center.

FIG. 7(2) illustrates the second pattern of the position of the circumscribed frame R. The second pattern is a pattern in which all four vertexes of the circumscribed frame R are included in one region of the first to fourth regions. The second pattern is a pattern in which the circumscribed frame R including the object to be conveyed 4 appears only in any one of the first to fourth regions.

FIGS. 7(3) and 7(4) illustrate the third pattern of the position of the circumscribed frame R. The third pattern is a pattern in which four vertexes of the circumscribed frame R are located individually in two regions. The third pattern illustrated in FIG. 7(3) includes a case where the circumscribed frame R including the object to be conveyed 4 extends over the first and second regions and a case where the circumscribed frame R extends over the third and fourth regions. The third pattern illustrated in FIG. 7(4) includes cases where the circumscribed frame R including the object to be conveyed 4 is included in two regions, such as a case where the circumscribed frame R extends over the second and third regions and a case where the circumscribed frame R extends over the first and fourth regions.

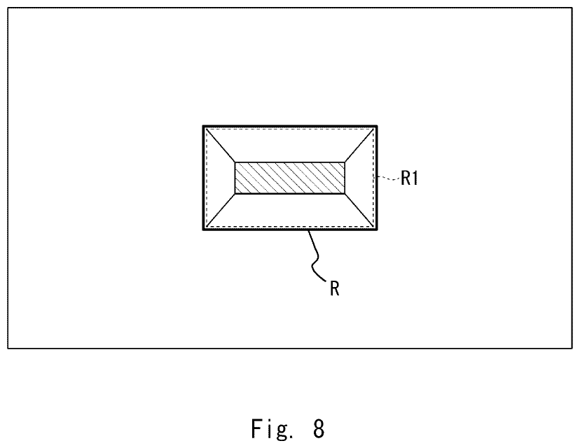

FIG. 8 is a diagram illustrating an example of an imaged state of the object to be conveyed, in a case where the position of the circumscribed frame R is in the first pattern. In a case where the position of the circumscribed frame R detected by the surveying unit 14 is in the first pattern, the upper surface of the object to be conveyed 4 appears in the captured image, but a side surface does not appear in the captured image. As the upper surface of the object to be conveyed 4 approaches the sensor 2, the region of the upper surface in the captured image becomes wider. FIG. 8 indicates that circumscribed frame R substantially coincides with a region R1 indicating the upper surface of the object to be conveyed 4.

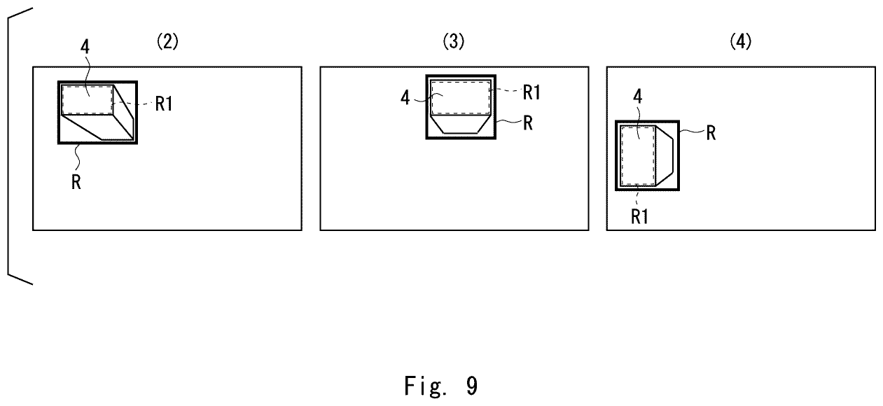

FIG. 9 is a diagram illustrating an example of an imaged state of the object to be conveyed, in a case where the position of the circumscribed frame R is in the second or third pattern. In a case where the position of the circumscribed frame R detected by the surveying unit 14 is in the second pattern, as illustrated in FIG. 9(2), the upper surface of the object to be conveyed 4 and a surface of the object to be conveyed 4 that can be linearly connected to the position of the sensor 2 are included in the captured image. In a case where the position of the circumscribed frame R detected by the surveying unit 14 is in the third pattern, the object to be conveyed 4 is included in the captured image as in FIGS. 9(3) and 9(4).

In a case where coordinates of pixels within the range of the circumscribed frame R are included in all four regions of the first to fourth regions divided using the vertical line and the horizontal line passing through the center of the measurement range, the surveying unit 14 determines that the circumscribed frame R is in the first pattern. In a case where all coordinates of pixels within the range of the circumscribed frame R are included in only one region of the four regions of the first to fourth regions divided using the vertical line and the horizontal line passing through the center of the measurement range, the surveying unit 14 determines that the circumscribed frame R is in the second pattern. In a case where coordinates of pixels within the circumscribed frame R are located in two regions separated by the vertical line 51 passing through the center of the measurement range or in a case where coordinates of pixels within the circumscribed frame R are located in two regions separated by the horizontal line 52 passing through the center of the measurement range, the surveying unit 14 determines that the circumscribed frame R is in the third pattern.

Returning to FIG. 5, the surveying unit 14 identifies a first particular region R1 indicating the upper surface of the object to be conveyed 4 in the captured image (step S109). The surveying unit 14 identifies the first particular region R1 in accordance with an identification method deduced in accordance with the identified pattern. The identification methods in each pattern will be described in detail later.

Next, using the first particular region, the surveying unit 14 identifies a region of the object to be conveyed 4 at a height at which the conveying vehicle 3 comes into contact with the object to be conveyed 4, as a second particular region R2 (step S110). A method for identifying the second particular region R2 will be described in detail later.

Next, the contact position identification unit 15 acquires information on the second particular region R2, as a region of the object to be conveyed 4 at a height h at which the conveying vehicle 3 comes into contact with the object to be conveyed 4. For example, the contact position identification unit 15 may acquire information on a feature point indicating the second particular region R2. The contact position identification unit 15 identifies the position in the captured image at which the conveying vehicle 3 comes into contact with the object to be conveyed 4, based on the information on a feature point indicating the second particular region R2 (step S111).

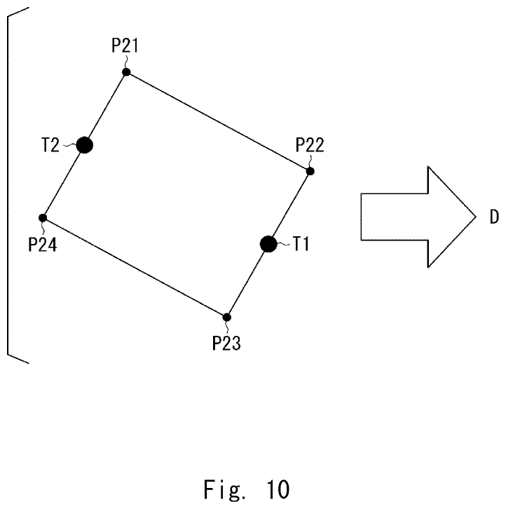

FIG. 10 is a diagram illustrating an outline of a contact position identifying process. As an example, in a case where the rectangular shape of the second particular region R2 indicates feature points P21, P22, P23, and P24, the contact position identification unit 15 may identify the center of any side of the second particular region R2, as a contact position T1 in the captured image at which the conveying vehicle 3 comes into contact with the object to be conveyed 4. For example, the contact position identification unit 15 may identify a first side connecting the feature points P21 and P22 and a second side connecting the feature points P22 and P23 at a side of a conveyance direction D. The contact position identification unit 15 may identify the center of the second side having a smaller angle formed with the conveyance direction D, among normal lines of the first and second sides, as the contact position T1 in the captured image at which the conveying vehicle 3 comes into contact with the object to be conveyed 4. The contact position identification unit 15 outputs the contact position T1 to the conveyance control unit 16. For example, the conveying vehicle 3 may come into contact with the object to be conveyed 4 at the contact position T1 of the object to be conveyed 4 and tow the object to be conveyed 4 in the conveyance direction D.

The contact position identification unit 15 may identify a center T2 of a side on an opposite side of the conveyance direction D and having a normal line with a smaller angle formed with the conveyance direction, among the sides of the second particular region R2, as a contact position P in the captured image at which the conveying vehicle 3 comes into contact with the object to be conveyed 4. That is, the contact position identification unit 15 may identify a third side connecting the feature points P21 and P24 and a fourth side connecting the feature points P24 and P23 on an opposite side of the conveyance direction D. The contact position identification unit 15 may identify the center of the third side having a normal line with a smaller angle formed with the conveyance direction D, among the third and fourth sides, as a contact position T2 in the captured image at which the conveying vehicle 3 comes into contact with the object to be conveyed 4. The contact position identification unit 15 outputs the contact position T2 to the conveyance control unit 16. In this case, the conveying vehicle 3 may come into contact with the object to be conveyed 4 at the contact position of the object to be conveyed 4 and push the object to be conveyed 4 in the conveyance direction D to convey the object to be conveyed 4.

Returning to FIG. 5, the conveyance control unit 16 converts the contact positions T1 and T2 in the captured image into contact positions T1′ and T2′ in the real space (step S112). For example, the conveyance control unit 16 stores, in advance, the relationship between coordinates in a virtual space indicated by the captured image and coordinates in the real space and converts the contact positions T1 and T2 into the contact positions T1′ and T2′ in the real space, based on the stored correspondence relationship.

The conveyance control unit 16 transmits the contact positions T1′ and T2′ in the real space and the conveyance direction of the object to be conveyed 4 to the conveying vehicle 3 (step S113). The conveying vehicle 3 moves toward the contact positions T1′ and T2′, comes into contact with the contact positions T1′ and T2′, and conveys the object to be conveyed, in the conveyance direction.

In the above description, it has been described that the object to be conveyed 4 is conveyed using two conveying vehicles 3, but the object to be conveyed 4 may be conveyed using a plurality of conveying vehicles 3 equal to or more than two, or the object to be conveyed 4 may be conveyed using one conveying vehicle 3. For example, four conveying vehicles 3 may come into contact with the object to be conveyed 4 from four directions to convey the object to be conveyed 4, or one conveying vehicle 3 may come into contact with any surface of the object to be conveyed 4 to convey the object to be conveyed 4 in such a way as to tow or push into the object to be conveyed 4. Here, the conveyance method will be described using the example in FIG. 8. The conveyance control unit 16 transmits the contact position T1 to a first conveying vehicle 3 and transmits the contact position T3 to a second conveying vehicle 3. The conveyance control unit 16 also transmits the conveyance direction D to the first and second conveying vehicles 3. The first conveying vehicle 3 comes into contact with the contact position T1 of the object to be conveyed 4. The second conveying vehicle 3 comes into contact with the contact position T2 of the object to be conveyed 4. The first and second conveying vehicles 3 may convey the object to be conveyed 4 in the conveyance direction by sandwiching the object to be conveyed 4.

In the above description, it has been described that the conveying vehicle 3 comes into contact with the object to be conveyed 4, but the method by which the conveying vehicle 3 acts on the object to be conveyed 4 is not limited. For example, the conveying vehicle 3 may press a tool of the conveying vehicle against the object to be conveyed 4, may connect or push (fit) a tool into a recess or a protrusion of the object to be conveyed 4, or may absorb an impact from the object to be conveyed 4. The conveying vehicle 3 may grab and tow the object to be conveyed 4 with a tool for sandwiching the object to be conveyed 4 from two directions.

For example, in a case where each of the first and second conveying vehicles 3 comes into contact with the object to be conveyed 4 to convey the object to be conveyed 4, the second conveying vehicle 3 applies a first force F1 to the contact position T2 and goes forward in a traveling direction. The first conveying vehicle 3 applies a second force F2 smaller than the first force F1 to the contact position T1 and goes forward in the same conveyance direction at the same speed as the first conveying vehicle 3. The two conveying vehicles of the first and second conveying vehicles 3 thus convey the object to be conveyed 4. Alternatively, for example, the first conveying vehicle 3 may be connected to the contact position T1 to tow the object to be conveyed 4, and the second conveying vehicle 3 may go forward in the conveyance direction while applying a force to the contact position T2 and controlling the object to be conveyed 4 in such a way as not to wobble. Alternatively, the second conveying vehicle 3 may be connected to the contact position T2 to push the object to be conveyed 4 in the conveyance direction, and the first conveying vehicle 3 may go forward in the conveyance direction while applying a force to the contact position T1 and controlling the object to be conveyed 4 in such a way as not to wobble.

According to the process of the conveyance system described above, the position at which the conveying vehicle comes into contact with the object to be conveyed can be identified. According to the process of the conveyance system described above, the contact position for the conveying vehicle with the object to be conveyed can be identified with higher accuracy. Furthermore, according to the process of the conveyance system 100 described above, even in a case where the region of the object to be conveyed 4 appearing in the captured image is different according to the height (the distance from the sensor 2) of the object to be conveyed 4 and the positional relationship between the object to be conveyed 4 and the sensor 2, the contact position at which the conveying vehicle 3 can come into contact with the object to be conveyed 4 can be calculated with higher accuracy.

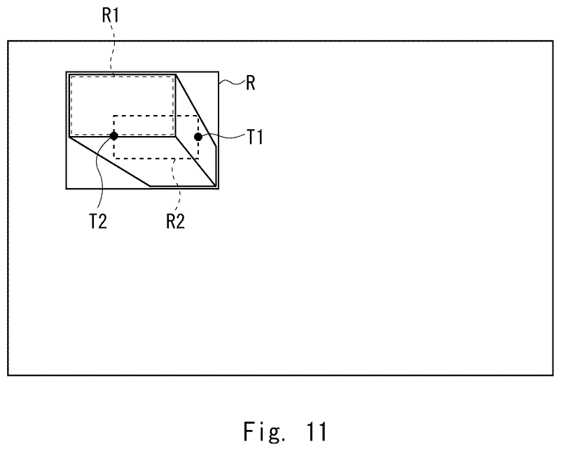

FIG. 11 is a diagram illustrating an example of display information. The display unit 17 outputs information identified by the control device 1 to a predetermined output destination. For example, the display unit 17 may acquire the captured image that has been subjected to processing, and the circumscribed frame R, the first particular region R1, and the second particular region R2 from the surveying unit 14. The display unit 17 also acquires the contact position calculated based on the second particular region R2. The display unit 17 generates the display information for displaying the captured image, the circumscribed frame R, the first particular region R1, the second particular region R2, and the contact position. The display unit 17 outputs the display information to a predetermined output destination. For example, the display unit 17 may output the display information to a display such as a liquid crystal display (LCD) provided in the control device 1, a monitor, or a terminal communicatively connected to the control device 1. This allows the administrator or the like to confirm the current control state of the conveyance system. The display unit 17 may display information on the circumscribed frame R, the first particular region R1, the second particular region R2, and the contact position in a superimposed manner as the display information, or may display each piece of information separately. Alternatively, the display unit 17 may generate the display information for displaying any information selected by a worker who performs the work, in a superimposed manner.

Subsequently, a process for the surveying unit 14 to calculate the first particular region R1 and the second particular region R2 will be described in detail below.

### (Process of Surveying Unit 14 in First Pattern)

In a case where the surveying unit 14 has determined that the disposition of a surface of the object to be conveyed 4, that is, the position of the circumscribed frame R is in the first pattern, the surveying unit 14 determines that the region of the circumscribed frame R is the upper surface of the object to be conveyed 4. The surveying unit 14 identifies particular regions (the first particular region R1 and the second particular region R2) at a predetermined height of the object to be conveyed 4 included in the region of the circumscribed frame R, based on the circumscribed frame R and height information on the circumscribed frame R. The second particular region R2 indicates a location where the object to be conveyed 4 is instructed by the moving body.

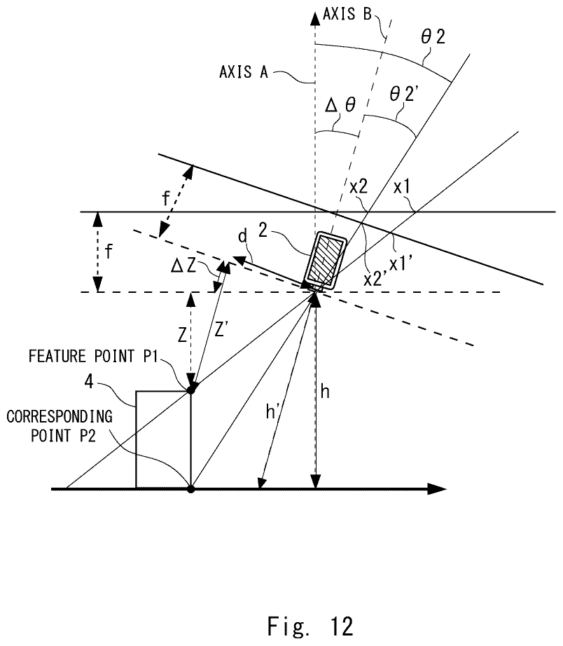

Here, a method for calculating the second particular region R2 of the object to be conveyed will be described with reference to FIG. 12. The positions of the sensor 2 and the object to be conveyed 4 in FIG. 12 are similar to those in FIG. 6. In FIG. 12, a corresponding point P2 is illustrated as a point on the object to be conveyed 4 arranged at a height at which the conveying vehicle 3 comes into contact with the object to be conveyed 4. The corresponding point P2 denotes a position on a plane substantially parallel to the upper surface of the object to be conveyed 4 including the feature point P1 and is a point arranged at a position substantially directly below the feature point P1. The corresponding point P2 is arranged on a plane at a height at which the conveying vehicle 3 comes into contact with the object to be conveyed 4. Here, the position of x2′ relevant to the corresponding point P2 in the captured image captured by the sensor 2 installed in an inclined manner is calculated.

An angle formed by a straight line connecting the corresponding point P2 and the sensor 2 and the axis B is denoted by θ2′. An angle formed by a straight line connecting the corresponding point P2 and the sensor 2 and the axis A is denoted by θ2. A point x1′ denotes a position of the feature point P1 included in the captured image captured by the sensor 2 installed in an inclined manner and indicates a distance from the axis B. A point x2 denotes a position of the corresponding point P2 included in the captured image captured by the sensor 2 installed without inclination and indicates a distance from the axis A.

The height h is a distance from the sensor 2 to an intersection of the axis A and a plane at a height at which the conveying vehicle 3 comes into contact with the object to be conveyed 4. The height h is a known value worked out according to the standards on the conveying vehicle 3 and the installation position of the sensor 2. A height h′ is a distance from the sensor 2 to an intersection of the axis B (the imaging direction axis in the direction in which the image capturing device performs imaging) and the plane at the height at which the conveying vehicle 3 comes into contact with the object to be conveyed 4 (a plane horizontal at a height of a location where the object to be conveyed 4 is instructed). A height Z is a distance from the feature point P1 to a plane that is parallel to the plane at the height at which the conveying vehicle 3 comes into contact with the object to be conveyed 4 and is in contact with the sensor 2. A height Z′ is a distance from the feature point P1 to a plane obtained by inclining a plane parallel to the plane at the height at which the conveying vehicle 3 comes into contact with the object to be conveyed 4 and in contact with the sensor 2, by Δθ. That is, Z′ denotes a distance from the image capturing device to the feature point in the captured image (video).

A height ΔZ is a distance from an intersection of a straight line from the feature point P1 to a plane obtained by inclining the plane in contact with the sensor 2 by Δθ, and a plane parallel to the plane at the height at which the conveying vehicle 3 comes into contact with the object to be conveyed 4 and in contact with the sensor 2, to an intersection of the straight line and a plane obtained by inclining the plane in contact with the sensor 2 by Δθ.

A length d is a distance from an intersection of a straight line from the feature point P1 to a plane obtained by inclining the plane in contact with the sensor 2 by Δθ and a plane obtained by inclining the plane in contact with the sensor 2 by Δθ, to the sensor 2.

First, the positions of x2 and x2′ are expressed as following Formulas (5) and (6).

$$x 2 = f \cdot tan ( θ2 ) \qquad ( 5 )$$

$$x {2}^{′} = f \cdot tan ( {θ2}^{′} ) \qquad ( 6 )$$

Here, since θ2′=θ2−Δθ is true, Formula (6) is transformed into following Formula (7).

$$x {2}^{′} = f \cdot \frac{tan ( θ 2 ) - tan ( Δ θ )}{1 + tan ( θ2 ) \cdot tan ( Δ θ )} \qquad ( 7 )$$

Following Formula (8) also holds.

$$x 2 = \frac{Z \cdot x 1}{h} \qquad ( 8 )$$

Accordingly, following Formula (9) is derived.

$$tan ( θ 2 ) = \frac{x 2}{f} = \frac{x 1 \cdot \frac{Z}{h}}{f} \qquad ( 9 )$$

Furthermore, following Formulas (10) and (11) hold.

$$h = {h}^{′} \cdot cos ( Δθ ) \qquad ( 10 )$$

$$Z = ( {Z}^{′} - Δ Z ) \cdot cos ( Δθ ) \qquad ( 11 )$$

Here, ΔZ and d are expressed as in following Formulas (12) and (13). θ1′ denotes the angle described with reference to FIG. 6.

$$Δ Z = d \cdot tan ( Δθ ) \qquad ( 12 )$$

$$d = {Z}^{′} \cdot tan ( {θ1}^{′} ) \qquad ( 13 )$$

Thus, Z/h is expressed as Formula (14), using Formulas (10) to (13) and Formula (2).

$$\frac{Z}{h} = \frac{{Z}^{′} \cdot ( 1 - tan ( Δθ ) \cdot \frac{x {1}^{′}}{f} )}{{h}^{′}} \qquad ( 14 )$$

Following Formula (15) is derived by substituting Formula (14) into Formula (9).

$$tan ( θ 2 ) = \frac{1}{f} \cdot \frac{x {1}^{′} + f \cdot tan ( Δ θ )}{1 - \frac{x {1}^{′}}{f} \cdot tan ( Δ θ )} \cdot \frac{{Z}^{′} \cdot ( 1 - tan ( Δθ ) \cdot \frac{x {1}^{′}}{f} )}{{h}^{′}} \qquad ( 15 )$$

By substituting Formula (15) into Formula (7), x2′ is expressed using x1′, f, Z′, h′, and Δθ. A position of the feature point P1 in the captured image is denoted by x1′, and a focal length is denoted by f. Z′ may be measured, for example, by a stereo camera. The stereo camera is capable of acquiring the depth relevant to the designated coordinates by using the standard library. Therefore, Z′ corresponding to the depth relevant to the feature point P1 may be measured using a stereo camera with the feature point P1 as designated coordinates. In addition, h′ is expressed by Formula (10) with h′=h/cos (40), using the known value h and the known value Δθ.

That is, x2′ can be calculated using known information. The surveying unit 14 calculates a value of x2′ relevant to the position x1′ of each of the feature points P11, P12, P13, and P14 arranged at the positions of the vertexes of the upper surface that is the first particular region, that is, the vertexes of the circumscribed frame R. This allows the surveying unit 14 to identify corresponding points P21, P22, P23, and P24 of the feature points P11, P12, P13, and P14 and to identify a region obtained by connecting the corresponding points P21, P22, P23, and P24, as the second particular region R2.

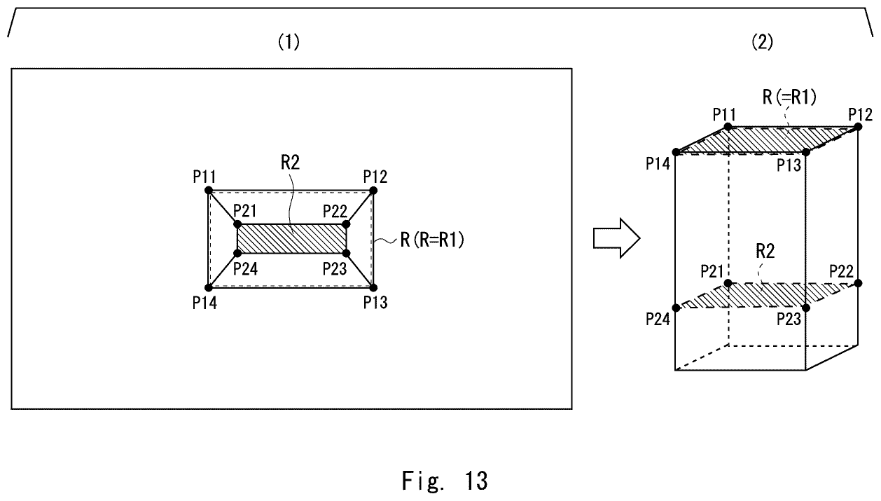

FIG. 13 is a diagram illustrating a relationship between the circumscribed frame R and the particular regions in the first pattern. FIG. 13(1) illustrates the object to be conveyed 4 shown in the captured image, and FIG. 13(2) illustrates a relevant perspective view of the object to be conveyed 4. It is assumed that the circumscribed frame R as the upper surface of the object to be conveyed 4 has been identified in the captured image. In a case where the position of the object to be conveyed 4 has been identified to be in the first pattern, the surveying unit 14 identifies the circumscribed frame R as the first particular region R1. The first particular region R1 in the first pattern is a region estimated to indicate the upper surface of the object to be conveyed 4.

The surveying unit 14 may identify a plurality of feature points of the circumscribed frame R having a shape other than a rectangular shape, based on that circumscribed frame R, and calculate a region obtained by connecting corresponding points relevant to the plurality of feature points, as the second particular region R2. The surveying unit 14 outputs information on the second particular region R2 to the contact position identification unit 15.

### (Process of Surveying Unit 14 in Second Pattern)

In a case where the surveying unit 14 determines that the position of the circumscribed frame R of the object to be conveyed 4 is in the second pattern, the circumscribed frame R identified in step S106 includes the upper surface and a side surface of the object to be conveyed 4. Accordingly, the surveying unit 14 identifies the first particular region R1 indicating the upper surface of the object to be conveyed 4 included in the region indicated by the circumscribed frame R as follows.

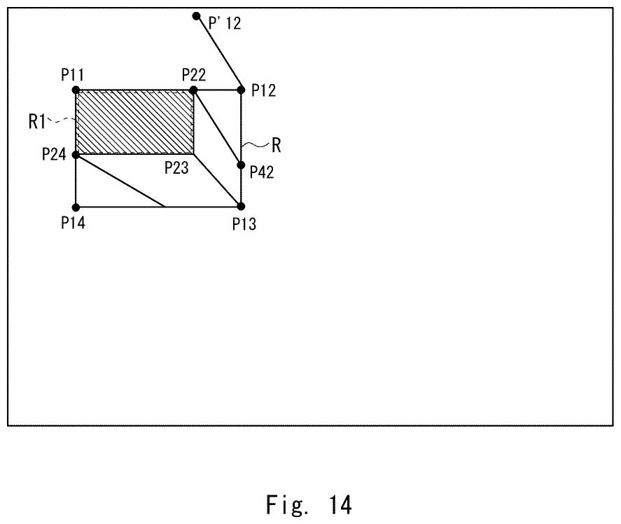

FIG. 14 is a first diagram illustrating a relationship between the circumscribed frame R and a particular region in the second pattern.

Specifically, the surveying unit 14 identifies the position of the feature point on the circumscribed frame R by a predefined approach, based on the shape of the circumscribed frame R and the pattern in accordance with the position of the circumscribed frame R. For example, in a case where the circumscribed frame R has a rectangular shape and the position of the circumscribed frame R is in the second pattern, four vertexes P11, P12, P13, and P14 of the circumscribed frame R are identified as feature points.

The surveying unit 14 calculates the distance Z′ from the feature point P11 farthest from the sensor 2, among the feature points P11, P12, P13, and P14 identified for the circumscribed frame R, using the distance information at P11. The distance Z′ is a distance from the feature point P11 to a plane obtained by inclining a plane in contact with the sensor 2 in the real space and parallel to a plane on which the conveying vehicle 3 comes into contact with the object to be conveyed 4, by Δθ. Here, the line between the point P12 and the point P22 in FIG. 14 is a line provided to set the circumscribed frame R, and the distance information associated with a feature point on this line does not indicate the distance from the sensor 2 to the upper surface of the object to be conveyed 4. Therefore, there is a difference larger than a predetermined value between the value indicated by the distance information associated with the point P22 and the value indicated by the distance information associated with a feature point up to the point P12. Meanwhile, the difference between the values indicated by the distance information associated with two feature points between the points P11 and P22 is smaller than the predetermined value because the difference indicates the distance from the sensor 2 to the upper surface of the object to be conveyed 4. For this reason, the surveying unit 14 extracts any feature point A that gives a difference larger than the predetermined value between the value indicated by the distance information associated with the feature point A on the line connecting the points P11 and P12 and the value indicated by the distance information associated with a feature point B adjacent to the feature point A. Such a feature point A is treated as the point P22 existing on the upper surface of the object to be conveyed 4.

Similarly, the surveying unit 14 extracts the feature point A that gives a difference from the value indicated by the distance information associated with the feature point B adjacent to the feature point A larger than the predetermined value, also on the line connecting the points P11 and P14. Such a feature point A is treated as the point P24 existing on the upper surface of the object to be conveyed 4.

The surveying unit 14 finds, as the point P23, an intersection of a straight line that is parallel to the straight line connecting the points P11 and P14 and passes through the point P22 and a straight line that is parallel to the straight line connecting the points P11 and P12 and passes through the point P24. The surveying unit 14 identifies a rectangular region obtained by connecting the points P11, P22, P23, and P24 found in this manner, as the first particular region R1 estimated to indicate the upper surface of the object to be conveyed 4 in the second pattern. The surveying unit 14 sets the points P11, P22, P23, and P24 as feature points (first corresponding points) of the first particular region R1.

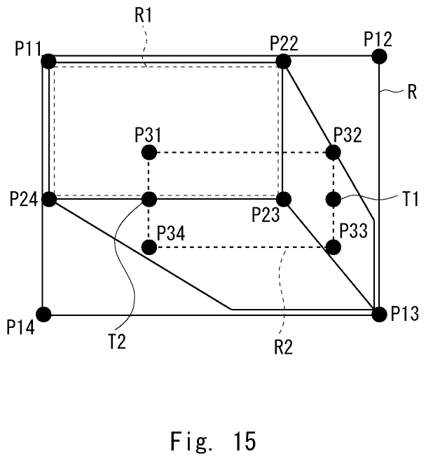

FIG. 15 is a second diagram illustrating a relationship between the circumscribed frame R and a particular region in the second pattern. The surveying unit 14 calculates corresponding points P31, P32, P33, and P34 at the height h at which the conveying vehicle 3 comes into contact with the object to be conveyed 4 and identifies the second particular region. Specifically, the surveying unit 14 calculates the corresponding points P31, P32, P33, and P34 relevant to a position on the object to be conveyed 4 with which the conveying vehicle 3 comes into contact, for the points P11, P22, P23, and P24, respectively, using the formula obtained by substituting Formula (15) into Formula (7). The surveying unit 14 identifies a rectangular region obtained by connecting the corresponding points P31, P32, P33, and P34 found in this manner, as the second particular region R2 of the object to be conveyed 4 in the second pattern. The surveying unit 14 sets the points P31, P32, P33, and P34 as feature points (second corresponding points) of the second particular region R2.

### (Process of Surveying Unit 14 in Third Pattern)

In a case where the surveying unit 14 determines that the position of the circumscribed frame R of the object to be conveyed 4 is in the third pattern, the circumscribed frame R identified in step S106 includes the upper surface and a side surface of the object to be conveyed 4. Accordingly, the surveying unit 14 identifies the first particular region R1 indicating the upper surface of the object to be conveyed 4 included in the region indicated by the circumscribed frame R as follows.

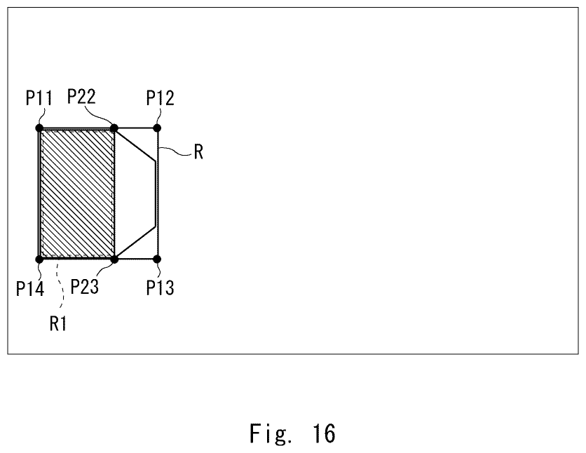

FIG. 16 is a diagram illustrating a relationship between the circumscribed frame R and a particular region in the third pattern. FIG. 16 illustrates the disposition of (4) in FIG. 6. Specifically, the surveying unit 14 identifies the position of the feature point on the circumscribed frame R by a predefined approach, based on the shape of the circumscribed frame R and the pattern in accordance with the position of the circumscribed frame R. For example, in a case where the circumscribed frame R has a rectangular shape and the position of the circumscribed frame R is in the third pattern, four vertexes P11, P12, P13, and P14 of the circumscribed frame R are identified as feature points.

The surveying unit 14 calculates the distance Z′ from each of the feature point P11 farthest from the sensor 2 in the second region and the feature point P14 farthest from the sensor 2 in the third region, among the feature points P11, P12, P13, and P14 identified on the circumscribed frame R, using the distance information at P11 and P14. Here, the line between the point P12 and the point P22 in FIG. 16 is a line provided to set the circumscribed frame R, and the distance information associated with a feature point on this line does not indicate the distance from the sensor 2 to the upper surface of the object to be conveyed 4. The same applies between the points P13 and P23. Therefore, there is a difference larger than a predetermined value between the value indicated by the distance information associated with the point P22 and the value indicated by the distance information associated with a feature point up to the point P12. Meanwhile, the difference between the values indicated by the distance information associated with two feature points between the points P11 and P22 is smaller than the predetermined value because the difference indicates the distance from the sensor 2 to the upper surface of the object to be conveyed 4. For this reason, the surveying unit 14 extracts any feature point A that gives a difference larger than the predetermined value between the value indicated by the distance information associated with the feature point A on the line connecting the points P11 and P12 and the value indicated by the distance information associated with a feature point B adjacent to the feature point A. Such a feature point A is treated as the point P22 existing on the upper surface of the object to be conveyed 4.

Similarly, the surveying unit 14 extracts the feature point A that gives a difference from the value indicated by the distance information associated with the feature point B adjacent to the feature point A larger than the predetermined value, also on the line connecting the points P14 and P13. Such a feature point A is treated as the point P23 existing on the upper surface of the object to be conveyed 4.

The surveying unit 14 identifies a rectangular region obtained by connecting the points P11, P22, P23, and 14 found in this manner, as the first particular region R1 estimated to indicate the upper surface of the object to be conveyed 4 in the second pattern. The surveying unit 14 sets the points P11, P22, P23, and 14 as feature points (first corresponding points) of the first particular region R1.

The surveying unit 14 further calculates the corresponding points P31, P32, P33, and P34 at the height h at which the conveying vehicle 3 comes into contact with the object to be conveyed 4 and identifies the second particular region. Specifically, the surveying unit 14 calculates the corresponding points P31, P32, P33, and P34 relevant to a position on the object to be conveyed 4 with which the conveying vehicle 3 comes into contact, for the points P11, P22, P23, and 14, respectively, using the formula obtained by substituting Formula (15) into Formula (7). The surveying unit 14 identifies a rectangular region obtained by connecting the corresponding points P31, P32, P33, and P34 found in this manner, as the second particular region R2 of the object to be conveyed 4 in the second pattern. The surveying unit 14 sets the points P31, P32, P33, and P34 as feature points (second corresponding points) of the second particular region R2.

As described above, by using the control device 1, even in a case where the sensor 2 is installed in an inclined manner, the positions of a plurality of feature points indicating the object to be conveyed appearing in a video are changed using the inclination of the sensor 2. Furthermore, the control device 1 identifies the shape of the object to be conveyed in accordance with the changed positions of the feature points. As a result, the control device 1 can appropriately identify the position of the object to be conveyed appearing in the captured image even in a case where the image capturing device is installed out of position. Moreover, the control device 1 can cause the moving body to reliably convey the object to be conveyed by appropriately identifying the position of the object to be conveyed.

### Third Example Embodiment

Subsequently, a method for calculating the second particular region R2 according to a third example embodiment will be described. In the third example embodiment, it is assumed that 01, 01′, 02, and 02′ are as small as possible. Based on such a premise, approximation of Formula (16) holds.

$$1 - tan ( θ {1}^{′} ) \cdot tan ( Δθ ) \approx 1 \qquad ( 16 )$$

Furthermore, Formula (17) also holds.

$$\frac{Z}{h} = \frac{{Z}^{′} \cdot ( 1 - tan ( Δθ ) \cdot tan ( {θ1}^{′} ) )}{h} \approx \frac{{Z}^{′}}{{h}^{′}} \qquad ( 17 )$$

Using Formula (16), Formula (3) is approximated as follows.

$$x 1 = f \cdot \frac{tan ( {θ1}^{′} ) + tan ( Δ θ )}{1 - tan ( {θ1}^{′} ) \cdot tan ( Δ θ )} \approx x {1}^{′} + f \cdot tan ( Δ θ ) \qquad ( 18 )$$

Furthermore, using Formulas (17) and (18), Formula (9) is approximated as follows.

$$tan ( θ 2 ) = \frac{x 2}{f} = \frac{x 1 \cdot \frac{Z}{h}}{f} \approx \frac{1}{f} \cdot ( x {1}^{′} + f \cdot tan ( Δ θ ) ) \cdot \frac{{Z}^{′}}{{h}^{′}} \qquad ( 19 )$$

Here, using Formula (19), Formula (7) is approximated as Formula (20).

$$x {2}^{′} = f \cdot \frac{tan ( θ 2 ) - tan ( Δ θ )}{1 + tan ( θ2 ) \cdot tan ( Δ θ )} \approx f \cdot ( tan ( θ 2 ) - tan ( Δ θ ) ) = \frac{x {1}^{′} \cdot {Z}^{′}}{{h}^{′}} + f \cdot ( \frac{{Z}^{′}}{{h}^{′}} - 1 ) \cdot tan ( Δθ ) \qquad ( 20 )$$

As described above, since Formula (20) is simplified as compared with the formula obtained by substituting Formula (15) into Formula (7), the processing load for calculating the second particular region R2 is reduced as compared with the second example embodiment.

For example, a control device 1 may calculate the second particular region R2, using Formula (20) in a case where the load on the control device 1 is higher than a predetermined value.

### Fourth Example Embodiment

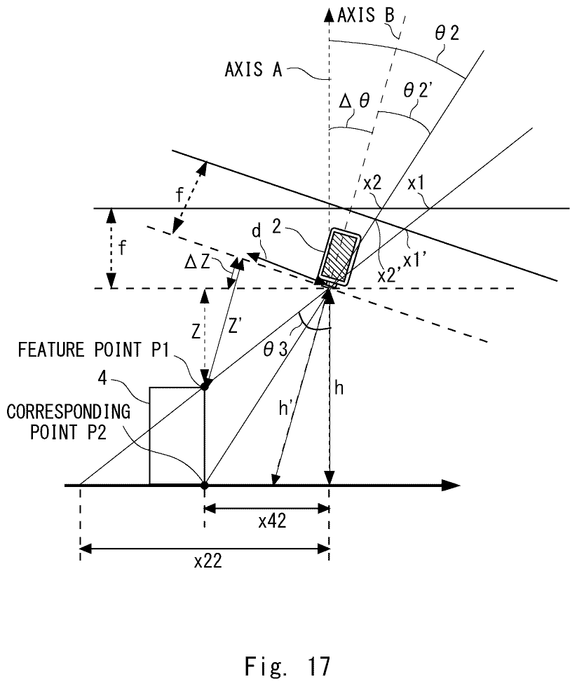

A method for identifying the first particular region R1 different from the method for identifying the first particular region R1 in the second example embodiment will be described. It is supposed that the feature point P1 in FIG. 17 is relevant to the point P22 in FIG. 14. It is further supposed that the corresponding point P2 in FIG. 17 is relevant to an intersection of a straight line from the point P22 toward a straight line connecting the points P12 and P13 and a straight line connecting the points P12 and P13 in FIG. 14. This intersection is defined as P42.

An intersection of the axis A and a plane at a height at which the conveying vehicle 3 comes into contact with the object to be conveyed 4 is defined as a reference point, a distance from the reference point to the corresponding point P2 is defined as x42, and a distance from the reference point to an intersection of a straight line connecting the feature point P1 and the sensor 2 and the plane at the height at which the conveying vehicle 3 comes into contact with the object to be conveyed 4 is defined as x22. An inclination between the axis A and a straight line connecting the feature point P1 and the sensor 2 is defined as θ3. In this case, x42 and x22 are expressed individually as the following formulas.

$$x 42 = Z \cdot tan ( θ3 ) \qquad ( 21 )$$

$$x 22 = h \cdot tan ( θ3 ) \qquad ( 22 )$$

From Formulas 21 and 22, the relationship between x22 and x42 is expressed using the following formula. In FIG. 17, since the sensor 2 is inclined, Z in Formula 21 is replaced with Z′, h in Formula 22 is replaced with h′, and also in Formula 23, Z is replaced with Z′, and h is replaced with h′.

$$x 22 = \frac{h}{Z} x 42 \qquad ( 23 )$$

The value of h′/Z′ in Formula 23 is worked out from Formula 14.

Formula 23 indicates a conversion equation for the x coordinate used to lift point P42 is lifted to the upper surface. Here, a point used to lift point P12 is lifted to the upper surface is defined as a point P′12, and a point used to lift point P13 is lifted to the upper surface is defined as a point 23. At this time, the point P22 in FIG. 14 is found by finding an intersection of a straight line connecting the points P11 and P12 and a straight line connecting the points P′12 and P23. The point P24 in FIG. 14 is found similarly to the point 22. As a result, since the points P11, P22, P23, and P24 can be identified, the first particular region R1 can be identified.

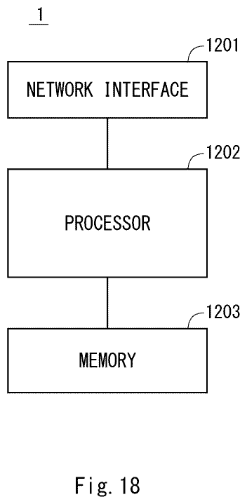

FIG. 18 is a block diagram illustrating a configuration example of the control device 1. Referring to FIG. 18, the control device 1 includes a network interface 1201, a processor 1202, and a memory 1203. The network interface 1201 may be used to communicate with network nodes. The network interface 1201 may include, for example, a network interface card (NIC) conforming to IEEE 802.3 series. The IEEE represents the Institute of Electrical and Electronics Engineers.

The processor 1202 performs the processes of the control device 1 described with reference to the flowcharts in the above example embodiments, by reading software (computer programs) from the memory 1203 and executing the software. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 via an input/output (I/O) interface (not illustrated).

In the example in FIG. 18, the memory 1203 is used to store a software module group. The processor 1202 can perform the processes of the control device 1 by reading the software module group from the memory 1203 and executing the read software module group.

As described with reference to FIG. 18, each of the processors included in the control device 1 executes one or a plurality of programs including a command group for causing a computer to perform the algorithm described with reference to the drawings.

In the example described above, the program includes a command group (or software codes) for causing a computer to perform one or more functions described in the example embodiments in a case where the program is read by the computer. The program may be stored in a non-transitory computer-readable medium or a tangible storage medium. By way of example and not by way of limitation, a computer-readable medium or tangible storage medium includes a random-access memory (RAM), a read-only memory (ROM), a flash memory, a solid-state drive (SSD), or other memory techniques, a compact disc read-only memory (CD-ROM), a digital versatile disc (DVD), a Blu-ray (registered trademark) disc, or other optical disc storages, a magnetic cassette, a magnetic tape, a magnetic disk storage, or other magnetic storage devices. The program may be transmitted through a transitory computer-readable medium or a communication medium. By way of example and not by way of limitation, a transitory computer-readable or communication medium includes electrical, optical, acoustic, or other forms of propagated signals.

Note that the technical ideas of the present disclosure are not limited to the above example embodiment and can be appropriately modified without departing from the scope. For example, the technical ideas of the present disclosure can also be applied to a belt conveyer system.

Some or all of the above-described example embodiments may be described as the following Supplementary Notes, but are not limited to the following.

### (Supplementary Note 1)

A control system including:
a change unit for, in accordance with an inclination of an image capturing device that has captured a first video, changing position information relating to a plurality of feature points indicating an object to be conveyed that appears in the first video;
a selecting unit for selecting a method for identifying disposition of a surface of the object to be conveyed, using the changed position information relating to the feature points; and
a control unit for controlling a moving body for conveying the object to be conveyed, in accordance with the disposition of the surface of the object to be conveyed identified in accordance with the selected method for the identifying.

### (Supplementary Note 2)

The control system according to Supplementary Note 1, in which the change unit changes the position information relating to the feature points to position information at which the feature points are located in a case where the image capturing device is installed facing a particular direction.

### (Supplementary Note 3)

The control system according to Supplementary Note 2, in which the inclination is an angle formed by an imaging direction axis in a case where the image capturing device is installed facing the particular direction and an imaging direction axis in a direction in which the image capturing device performs imaging.

### (Supplementary Note 4)

The control system according to any one of Supplementary Notes 1 to 3, in which the selecting unit selects the method for the identifying, in accordance with a region including the changed position information relating to the feature points, among regions obtained by dividing a measurement range of the image capturing device installed facing the particular direction into a plurality of regions.

### (Supplementary Note 5)

The control system according to any one of Supplementary Notes 1 to 3, in which the change unit changes the position information relating to a feature point on a rectangular shape including the object to be conveyed, among the plurality of feature points, using the inclination.

### (Supplementary Note 6)

The control system according to any one of Supplementary Notes 1 to 3, further including an identification unit for identifying a location where the object to be conveyed is supported by the moving body, using distance information indicating a distance from the image capturing device to a feature point in the first video and the disposition of a surface of the object to be conveyed, in which the control unit controls the moving body in accordance with the identified location where the object to be conveyed is supported and the identified disposition of the surface of the object to be conveyed.

### (Supplementary Note 7)

The control system according to Supplementary Note 6, in which the control unit identifies the location where the object to be conveyed is supported, further using a distance from the image capturing device to an intersection of an imaging direction axis in a direction in which the image capturing device performs imaging and a plane horizontal at a height of the location where the object to be conveyed is supported.

### (Supplementary Note 8)

A control device including:
a change unit for, in accordance with an inclination of an image capturing device that has captured a first video, changing position information relating to a plurality of feature points indicating an object to be conveyed that appears in the first video;
a selecting unit for selecting a method for identifying disposition of a surface of the object to be conveyed, using the changed position information relating to the feature points; and
a control unit for controlling a moving body for conveying the object to be conveyed, in accordance with the disposition of the surface of the object to be conveyed identified in accordance with the selected method for the identifying.

### (Supplementary Note 9)

The control device according to Supplementary Note 8, in which the change unit changes the position information relating to the feature points to position information at which the feature points are located in a case where the image capturing device is installed facing a particular direction.

### (Supplementary Note 10)

A control method including:
in accordance with an inclination of an image capturing device that has captured a first video, changing position information relating to a plurality of feature points indicating an object to be conveyed that appears in the first video;
selecting a method for identifying disposition of a surface of the object to be conveyed, using the changed position information relating to the feature points; and
controlling a moving body for conveying the object to be conveyed, in accordance with the disposition of the surface of the object to be conveyed identified in accordance with the selected method for the identifying.

### (Supplementary Note 11)

A program for causing a computer to execute:
in accordance with an inclination of an image capturing device that has captured a first video, changing position information relating to a plurality of feature points indicating an object to be conveyed that appears in the first video;
selecting a method for identifying disposition of a surface of the object to be conveyed, using the changed position information relating to the feature points; and
controlling a moving body for conveying the object to be conveyed, in accordance with the disposition of the surface of the object to be conveyed identified in accordance with the selected method for the identifying.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example for describing one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures to explain illustrative example embodiments are not necessarily mandatory, and some features or steps may be omitted. The order of the steps described in any of the figures may be changed as appropriate.

Some or all of the elements (such as constituents and functions) described in Supplementary Notes 2 to 7 subordinate to Supplementary Note 1 may be subordinate also to Supplementary Notes 8, 10, and 11 with a subordinate relationship similar to that of Supplementary Notes 2 to 7. Some or all of the elements described in any Supplementary Note may be applied to various types of hardware, software, recording means for recording software, systems, and methods.

This application is based upon and claims the benefit of priority from Japanese patent application No. 2023-040571, filed on Mar. 15, 2023, the disclosure of which is incorporated herein in its entirety by reference.

### REFERENCE SIGNS LIST

1 control device
2 sensor
3 conveying vehicle
4 object to be conveyed
11 image information acquisition unit
12 distance information acquisition unit
13 difference detection unit
14 surveying unit
15 contact position identification unit
16 conveyance control unit
17 display unit
18 inclination information acquisition unit
19 survey correction unit
100 control system
110 change unit
120 selecting unit
130 control unit
101 conveyance system

What is claimed is:

1. A control system comprising:
at least one memory storing instructions; and
at least one processor configured to execute the instructions to,
in accordance with an inclination of an image capturing device that has captured a first video, change position information relating to a plurality of feature points indicating an object to be conveyed that appears in the first video;
select a method for identifying disposition of a surface of the object to be conveyed, using the changed position information relating to the feature points; and
control a moving body for conveying the object to be conveyed, in accordance with the disposition of the surface of the object to be conveyed identified in accordance with the selected method for identifying.

2. The control system according to claim 1, wherein the at least one processor is further configured to execute the instructions to change the position information relating to the feature points to position information at which the feature points are located in a case where the image capturing device is installed facing a particular direction.

3. The control system according to claim 2, wherein the inclination is an angle formed by an imaging direction axis in a case where the image capturing device is installed facing the particular direction and an imaging direction axis in a direction in which the image capturing device performs imaging.

4. The control system according to claim 1, wherein the at least one processor is further configured to execute the instructions to select the method for the identifying, in accordance with a region including the changed position information relating to the feature points, among regions obtained by dividing a measurement range of the image capturing device installed facing the particular direction into a plurality of regions.

5. The control system according to claim 1, wherein the at least one processor is further configured to execute the instructions to change the position information relating to a feature point on a rectangular shape including the object to be conveyed, among the plurality of feature points, using the inclination.

6. The control system according to claim 1, wherein the at least one processor is further configured to execute the instructions to identify a location where the object to be conveyed is supported by the moving body, using distance information indicating a distance from the image capturing device to a feature point in the first video and the disposition of a surface of the object to be conveyed,
wherein the control means controls the moving body in accordance with the identified location where the object to be conveyed is supported and the identified disposition of the surface of the object to be conveyed.

7. The control system according to claim 6, wherein the at least one processor is further configured to execute the instructions to identify the location where the object to be conveyed is supported, further using a distance from the image capturing device to an intersection of an imaging direction axis in a direction in which the image capturing device performs imaging and a plane horizontal at a height of the location where the object to be conveyed is supported.

8-9. (canceled)

10. A control method comprising:
in accordance with an inclination of an image capturing device that has captured a first video, changing position information relating to a plurality of feature points indicating an object to be conveyed that appears in the first video;
selecting a method for identifying disposition of a surface of the object to be conveyed, using the changed position information relating to the feature points; and
controlling a moving body for conveying the object to be conveyed, in accordance with the disposition of the surface of the object to be conveyed identified in accordance with the selected method for the identifying.

11. The control method according to claim 10, further comprising, in changing the position information relating to the feature points, changing the position information relating to the feature points to position information at which the feature points are located in a case where the image capturing device is installed facing a particular direction.

12. The control method according to claim 11, wherein the inclination is an angle formed by an imaging direction axis in a case where the image capturing device is installed facing the particular direction and an imaging direction axis in a direction in which the image capturing device performs imaging.

13. The control method according to claim 10, further comprising, in selecting the method for the identifying the disposition of the surface of the object to be conveyed, selecting the method for the identifying, in accordance with a region including the changed position information relating to the feature points, among regions obtained by dividing a measurement range of the image capturing device installed facing the particular direction into a plurality of regions.

14. The control method according to claim 10, further comprising, in changing the position information relating to the feature points, changing the position information relating to a feature point on a rectangular shape including the object to be conveyed, among the plurality of feature points, using the inclination.

15. The control method according to claim 10, further comprising:
identifying a location where the object to be conveyed is supported by the moving body, using distance information indicating a distance from the image capturing device to a feature point in the first video and the disposition of a surface of the object to be conveyed; and
in controlling the moving body, controlling the moving body in accordance with the identified location where the object to be conveyed is supported and the identified disposition of the surface of the object to be conveyed.

16. The control method according to claim 15, further comprising, in controlling the moving body, identifying the location where the object to be conveyed is supported, further using a distance from the image capturing device to an intersection of an imaging direction axis in a direction in which the image capturing device performs imaging and a plane horizontal at a height of the location where the object to be conveyed is supported.

17. A non-transitory computer-readable medium storing a program for causing a computer to execute:
in accordance with an inclination of an image capturing device that has captured a first video, changing position information relating to a plurality of feature points indicating an object to be conveyed that appears in the first video;
selecting a method for identifying disposition of a surface of the object to be conveyed, using the changed position information relating to the feature points; and
controlling a moving body for conveying the object to be conveyed, in accordance with the disposition of the surface of the object to be conveyed identified in accordance with the selected method for the identifying.

18. The non-transitory computer-readable medium according to claim 17, further comprising, in changing the position information relating to the feature points, changing the position information relating to the feature points to position information at which the feature points are located in a case where the image capturing device is installed facing a particular direction.

19. The non-transitory computer-readable medium according to claim 18, wherein the inclination is an angle formed by an imaging direction axis in a case where the image capturing device is installed facing the particular direction and an imaging direction axis in a direction in which the image capturing device performs imaging.

20. The non-transitory computer-readable medium according to claim 17, further comprising, in selecting the method for the identifying the disposition of the surface of the object to be conveyed, selecting the method for the identifying, in accordance with a region including the changed position information relating to the feature points, among regions obtained by dividing a measurement range of the image capturing device installed facing the particular direction into a plurality of regions.
